(19) United States
(12) Patent Application Publication
(10) Pub. No.: US 2019/0217136 A1
(43) Pub. Date: Jul. 18, 2019

(54) Fire Retardant Delivery

(71) Applicant: 9Line LLC, Mountain Green, UT (US)

(72) Inventor: Paul Robert Delmonte, Mountain Green, UT (US)

(73) Assignee: 9Line LLC

(21) Appl. No.: 16/247,387

(22) Filed: Jan. 14, 2019

Related U.S. Application Data
(60) Provisional application No. 62/617,017, filed on Jan. 12, 2018.

(51) Int. Cl. A62C 31/00

(52) U.S. Cl. CPC A62C 31/00

(57) ABSTRACT

A technology is described for performing precision fire retardant or fire suppressant delivery from air-tankers or helicopters. A request can be received to release liquid fire retardant or fire suppressant. Drop door scheduling for the liquid can be calculated using fluid dynamics, air conditions data, airborne vehicle and target locations, digital terrain elevation data, and a ballistic model. A time point can be determined to open a drop door for an airborne vehicle based on the calculated release start point. The drop door can then be dynamically scheduled/controlled throughout the drop phase to continuously adjust for changing air vehicle, air conditions, and terrain variations.

### RELATED APPLICATIONS

The present application claims the benefit of U.S. Provisional Patent Application No. 62/617,017 filed Jan. 12, 2018 with a docket number of 4239-001.PROV, the entire specification of which is hereby incorporated by reference in its entirety.

### BACKGROUND

Changing weather patterns combined with wildland encroachment by a growing population has increased the complexity of fighting wildland fires. Compounding the situation, past decades of full fire suppression and restricted timber harvesting policies have resulted in dense amounts of flammable material accumulating in public grasslands and forests. The Wildland-Urban Interface (WUI) describes areas of expanding human population adjacent to natural landscapes that are growing rapidly with development. The need to leverage technology to make wildland firefighting more safe, effective, and efficient is vital to adjust strained resources to address the growing wildland fire threat.

Wildland fires occur on all types of land jurisdictions (e.g., federal, state and private) and pose a significant threat to life and property. Aerial firefighting is the use of aircraft and other aerial resources to combat wildland fires. The types of aircraft that may be used include fixed-wing aircraft, helicopters, and unmanned aerial systems (UAS). Chemicals used to fight fires may include water, water enhancers such as foams and gels, and specially formulated fire retardants.

Air-tankers or water bombers are fixed-wing aircraft fitted with tanks that can be filled on the ground at an air tanker base or, in the case of flying boats and amphibious aircraft, by scooping water from lakes, reservoirs, or large rivers. Retardant-loaded air-tankers and helicopters can drop fire retardants that use ammonium sulfate or ammonium polyphosphate with attapulgite clay thickener or diammonium phosphate with thickener. These are not only less toxic but act as fertilizers to help the regrowth of plants after the fire. Fire retardants often contain wetting agents and are colored red with ferric oxide or fugitive color to mark where they have been dropped. Helicopters are similarly employed using tanks or suspended buckets and also drop all forms of retardants and fire suppressants.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1a illustrates dropping fire retardant in accordance with an example;

FIG. 1b illustrates a method of dropping fire retardant in accordance with an example;

FIG. 2 illustrates a method of dropping fire retardant in accordance with an example:

FIG. 3 illustrates fire retardant that is being placed into a ravine by an airborne vehicle in accordance with an example:

FIG. 4 illustrates fire retardant being placed by an airborne vehicle in the presence of wind in accordance with an example;

FIG. 5 illustrates modes that can be selected for dropping fire retardant in a desired area in accordance with an example:

FIG. 6 illustrates the path of an airborne vehicle over a hill in accordance with an example:

FIG. 7 illustrates the inputs and outputs of fire retardant delivery using a continuously-computed release point (CCRP) device in accordance with an example;

FIG. 8 is a flow chart illustrating a method for performing fire retardant delivery in accordance with an example:

FIG. 9 is a flow chart depicting functionality of an apparatus for performing fire retardant delivery in accordance with an example; and

FIG. 10 is a block diagram illustrating an example of a computing device that may be used for performing fire retardant delivery.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

In over seven decades of dropping liquids on fires, the National tanker fleet has evolved substantially from smaller World War II planes, such as the TBM Avenger, to huge, complex, and faster modern jets, such as a Boeing 747. Yet during this time, the actual aiming of the liquid dropped on fires has not evolved. In the past, regardless of aerial platform, pilots have been dropping the liquids or fire retardants manually. Due to this rudimentary manual aiming, it is not uncommon when some or all of a retardant (or suppressant) drop does not land in the desired location. Dropping liquids, such as retardants or fire suppressants, from modern jets using manual aiming has dramatically increased costs thereby exacerbating negative impacts of imprecise deliveries.

A technology is described that provides a more accurate and precise way of dropping retardants and suppressants on fires. A retardant delivery system can use algorithms and a controlling computer to continuously compute, direct, release, and schedule the delivery of fire suppressants (water, foam, gel) and retardants (sulfates, phosphates) to control wildland fire with improved accuracy. Multiple variables are input into a retardant delivery system via systems and methods of transferring data to a processor that in turn controls the tank and/or drop doors. The data can be transferred by means of a wired connection or a wireless connection. The retardant delivery system can be used on any aerial firefighting platform, including air-tankers and helicopters dropping any form of liquid fire suppressant or retardant. The use of the terms ‘retardant door’, ‘drop door’, ‘retardant gate’, ‘pintle’ or ‘retardant valve’; and ‘retardant’ or ‘fire suppressant’ are used interchangeably and all considered synonymous and can be applied to any airborne firefighting platform dispensing any form of liquid from any tank or suspended bucket to manage wildland fire.

The retardant delivery system can also include steering, a vertical clearance plane, and in-range cues to the pilot. The pilot of the airborne vehicle can be directed to follow the steering and vertical clearance cues to provide for improved placement of fire retardant in the desired area on the ground. For example, the retardant delivery system may provide electronic pilot cueing to guide a pilot to a drop point or a location for fire suppressant placement. An in-range cue can be provided to the pilot of the airborne vehicle by lights, audible tones, or other electronic means which can alert the pilot of an impending calculated release solution. In one example, the electronic means can include one or more of a heads-up display (HUD), a helmet-mounted cueing (HMC) device, augmented-reality (AR) headsets or other electronic systems which display in-range, steering and targeting cues as overlays to a real world view through the display or headset. If flight conditions are then satisfactory, the pilot can hold down a consent to release button which can authorize the retardant delivery system to commence release of the fire retardant upon reaching the continuously computed start point. This in-range operation can be defined as “consent-to-release.”

Upon receiving “consent to release” the, retardant delivery system can control both initial release and continuous drop door scheduling to adjust for wind, varying terrain features, and changing aircraft parameters (e.g., increasing airspeed in a dive). The drop door in the airborne vehicle can accurately dispense the fire retardant onto the ground in response to the calculations made. The drop door scheduling can incrementally open or incrementally close the drop door in response to the continuously changing location or height of the airborne vehicle. The dynamic opening or closing can occur at precise time points defined by the calculations. The opening and closing action can also occur at various rates based on rapidly changing head pressure in the tank as well as varying aircraft height over the ground. For example, a desired coverage level of 6 gallons per 100 square feet can result in a faster opening of the retardant door in comparison to a desired coverage level of 1 gallon per 100 square feet. Through continuous calculations the resulting coverage level across the ground can be uniform and consistent.

The varying or dynamic drop door scheduling can be continuously calculated based on various factors including fluid dynamics, air conditions data (pressure, temperature, wind etc.), aircraft position and attitude (speed, pitch, roll, yaw), a target location, changing topography elevations beneath the aircraft, and a ballistic model. A selected mode (e.g., drop start point, drop end point, drop start-stop points, center point drop, arcing drop, etc.) which defines a desired drop pattern on the ground, a digital terrain elevation database (DTED), global positioning system (GPS), and wide area augmentation system (WAAS) can also be inputs to retardant door scheduling. Fluid dynamics model the flow of gases and liquids in motion. Air conditions data can include such variables as static and dynamic pressure, static and dynamic temperature, and wind speed and direction. The location and attitude (pitch, roll, yaw) of the airborne vehicle and the location of the targeted area can also affect the drop door scheduling. Computed ballistics can model the retardant plume and therefore predict the flight of the fire retardant from the airborne vehicle to the ground. The pilot may select different modes to achieve desired retardant effects on the ground. DTED can be used in calculations to provide a matrix of terrain elevation values. GPS and WAAS can be used to determine the location of the airborne vehicle in relation to the location of the targeted area.

After the retardant door scheduling has been calculated based on one or more of the preceding factors, a time point can be determined to open the retardant door based on ballistic computations, and the pilot selected drop mode. A retardant delivery system can also provide more precise and continuously computed release rates as the underlying terrain changes. A DTED can be used to factor in the changes in elevation of the underlying terrain. This allows the door scheduling to dynamically change as fluid is evacuated from the tank which in turn provides for a more uniform coverage density across changing topography. Data for the calculations described above may also be received over a wireless data link.

The head pressure in the retardant tank may also be factor in calculating the drop door scheduling. The computations may factor in how head pressure will decrease as fluid is being released. Therefore, the rate at which the drop door is opening can increase over time to allow the later parts of the retardant load to get out quickly despite the fact that there is little to no head pressure remaining. So, for example in a coverage level 6 (pretty thick on the ground), the initial drop door opening is slow due to lots of head pressure and then as material or retardant is dropped the rate at which the drop door opens increases to drop the retardant out with the same density. In addition, the drop door opening rate may be modified (by rapidly widening and/or choking down) based on the changing topography under the aircraft. More specifically, an increase or decrease in distance to the ground while the aircraft remains level may be taken into account to modify the drop door opening rate (e.g. when crossing a ravine or other varying slopes). For example, if the aircraft is passing out of a ravine then the drop door opening rate may be reduced or even the size of the opening may be reduced because the aircraft is closer to the ground.

The drop door scheduling can also be determined based on the desired coverage level for the fire retardant. There may be as many as 10 different levels of coverage for fire retardant. A coverage level of 1 is a coverage level for fire retardant of 1 gallon per 100 square feet on the ground. A coverage level of 6 is defined as 6 gallons per 100 square feet on the ground. Coverage levels are pilot selected and based on fuel types, fire behavior, and desired effects. The retardant door scheduling can be determined to ensure the desired coverage level on the ground remains uniform in the presence of changes in the underlying terrain and the changes in the air conditions and other factors.

The retardant door scheduling can also be modified based on the height of the airborne vehicle. As the height of the airborne vehicle increases, the opening width for the retardant door can be increased to maintain a similar coverage level. As the height of the airborne vehicle decreases, the opening width for the retardant door can also be decreased. This can provide a more constant coverage level even as the height of the airborne vehicle changes in relation to the ground.

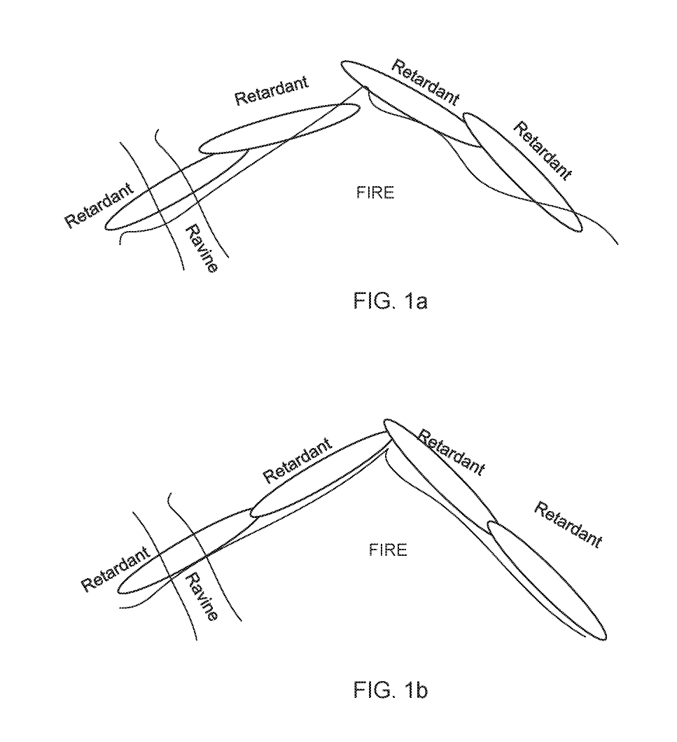

FIG. 1a illustrates an example of an existing manual method of dropping fire retardant on the ground. Existing manual release methods of delivering fire retardant to prevent the spread of a fire have various drawbacks. The end result is often inaccurate, ineffective or wasted retardant thereby requiring extra flights and drops to correct. Each oval corresponds to the fire retardant that has been dropped by an airborne vehicle. Ideally, the fire retardant can be dropped close to the edge of the fire without inadvertently wasting fire retardant in locations that have already burned.

Unfortunately, the fire retardant that has been dropped by one airborne vehicle can excessively overlap with the fire retardant that has been dropped by another airborne vehicle. Excessive overlap in dropped fire retardant can result in a significant amount of fire retardant wasted, redundant, or not effective in stopping the spread of the fire.

The fire retardant can also be dropped by each airborne vehicle in a line that deviates from the line in front of or provided by the fire's edge. Some of the fire retardant can be placed into the previously burned area, which does nothing to prevent the further spread of the fire. Some of the fire retardant can be placed far from the edge of the fire, which can allow the fire to unnecessarily spread beyond the area of containment.

Even if the fire retardant can be dropped near the line provided by the fire's edge, the coverage level of the fire retardant can deviate from the desired coverage level because of elevation changes in the terrain. For example, an airborne vehicle can drop fire retardant with a coverage level of 6 over a flat surface. However, if the airborne vehicle drops the fire retardant with a desired coverage level of 6 over a ravine, then the coverage level over the ravine can differ from the desired value of 6 because of the elevation changes throughout the ravine. At the deepest portion of the ravine, the coverage level can be lower than the desired value because of amplified dispersion effects due to longer fall times. Outside of the ravine, the coverage level can be closer to the desired value.

The current manual control of delivery methods can result in: significant waste of fire retardant; an increase in the amount of resources used to prevent the spread of the fire and an overall lack of efficiency. Leveraging rapid computing technology helps overcome some of these problems in fire retardant delivery.

FIG. 1b illustrates an example of a precision method of dropping fire retardant on the ground. Each oval corresponds to the fire retardant that has been dropped by a particular airborne vehicle. This method of dropping fire retardant onto the ground is closer to the ideal case, in which the fire retardant can be dropped close to the edge of the fire without placing fire retardant into locations that have been previously burnt.

This precision method also avoids some of the defects of the existing approach, and there is less overlap between the fire retardant dropped by each airborne vehicle. For example, each oval has a small overlap with the successive oval. This ensures more precisely placed lines of continuous containment by fire retardant can still effectively prevent the spread of the fire. This also prevents some of the wastage of fire retardant that occurs with the existing approach.

In FIG. 1b, there is also a ravine in which uniform retardant density can be placed. In the existing manual-release approach, the elevation changes in the terrain had the effect of varying the retardant coverage level applied to the ravine from the desired amount. In this delivery example, the changes in coverage level of the fire retardant caused by the elevation changes in the terrain can be avoided because more fire retardant can be dropped into the ravine as the ravine becomes deeper and less fire retardant can be dropped as the ravine becomes shallower.

Desired fire retardant placement can be determined from the desired fire retardant line. This fire retardant line can be determined by using: the starting point coordinates to an accuracy of 4 decimal digits (7 inches); the line of bearing of the airborne vehicle at the starting point coordinates; the stopping point coordinates to an accuracy of 4 decimal digits; and the line of bearing of the airborne vehicle to the stopping coordinates.

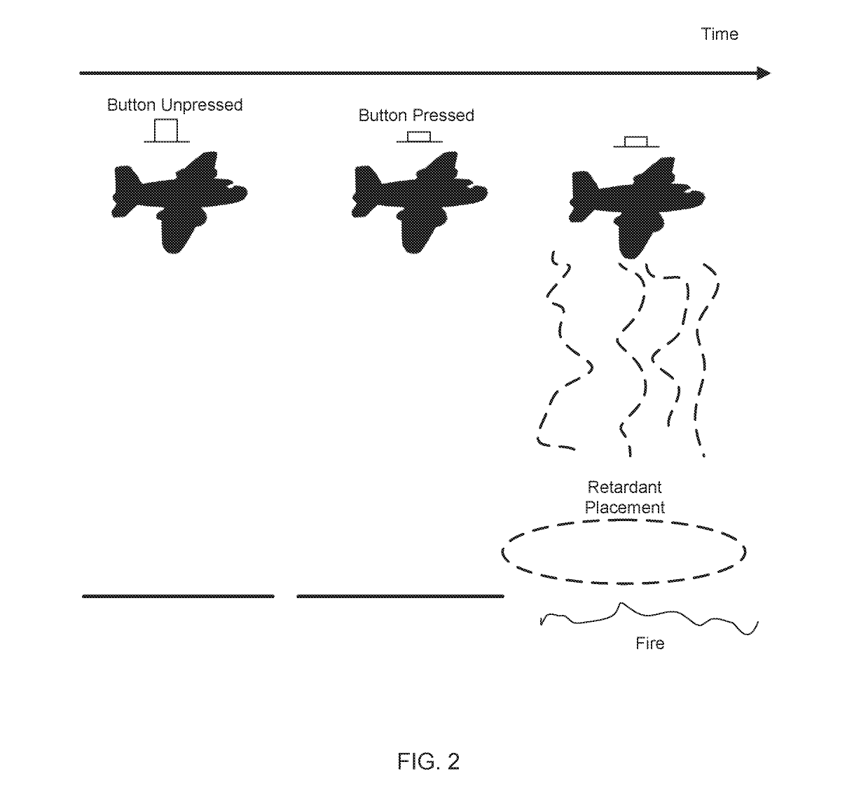

FIG. 2 illustrates an example of the “consent to release” method of dropping fire retardant which may provide increased precision. Shown is a time progression in three stages. In the first stage, the airborne vehicle is flying over an area of the ground without any fire. The airborne vehicle can have a button that can initiate a “consent-to-release” process. In the second stage, the “consent-to-release” button has been triggered; however, the fire retardant is not yet released from the airborne vehicle because the airborne vehicle has not reached the appropriate computed release location. In the third stage, the button has been previously triggered and the fire retardant is automatically released from the airborne vehicle because the computed location has been reached as calculated by a computer using the factors described earlier, including fluid dynamics, air data conditions, aircraft position and attitude, a target location, a ballistic model, a selected mode, a digital terrain elevation database (DTED), and a global positioning system (GPS) with wide area augmentation system (WAAS).

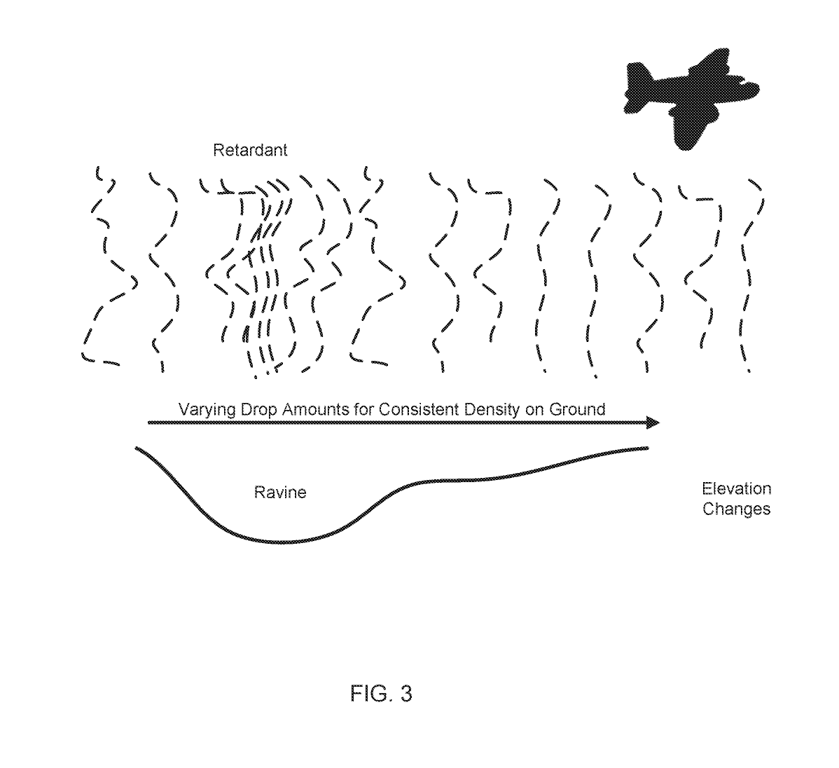

FIG. 3 illustrates how a DTED can be used to calculate the changes in elevation of the underlying terrain. Air conditions data (pressure, temperature, wind, etc.) and aircraft position and attitude (speed, pitch, roll, yaw) can be factored into calculating the trajectory of the dropped fire retardant. Using the changes in elevation of the underlying terrain, the air conditions data, and aircraft position and attitude, the retardant delivery system can determine retardant door scheduling to achieve a consistent density of retardant throughout the elevation changes. The opening width of the retardant door can be achieved based on the retardant door scheduling. The retardant door can also be closed based on the retardant door scheduling.

FIG. 3 illustrates an example of fire retardant that is being placed into a ravine by an airborne vehicle. The ravine quickly reaches its greater depth and then slowly becomes shallower as the fire retardant is dropped. In the areas of greater depth, more fire retardant can be dropped to compensate for the added airtime and wind exposure due to the increase in distance between the airborne vehicle and the ground in the ravine. In the areas of the ravine that are shallower, less fire retardant can be dropped to compensate for the decrease in distance between the airborne vehicle and the ground in the ravine.

In this example, the airborne vehicle can fly at an average altitude that is about 150 feet above the ground before reaching the ravine. The ravine can have an example depth of 40 feet, for a total distance of 190 feet between the airborne vehicle and the maximum depth of the ravine. Before reaching the ravine, the airborne vehicle can drop at a coverage level of 6 gallons per 100 square feet. Because the ground is flat at this point, the coverage level can be approximated by the desired level of 6 gallons per 100 square feet. Other factors such as a ballistic model of the fire retardant, coordinates of the airborne vehicle, the particular mode of dropping fire retardant, the air conditions data, the digital terrain elevation database (DTED), and a global positioning system (GPS) with wide area augmentation system (WAAS) can also be included in the calculation.

In this example, as the airborne vehicle reaches the ravine, the actual coverage level of 6 gallons per 100 square feet will fluctuate from the desired coverage level of 6 if the coverage level is not adjusted for the changes in elevation. This can result in a smaller coverage density than desired in the ravine bottom.

In this example, to avoid the fluctuations in the actual coverage level, the coverage level can be increased for the fire retardant dropped into the ravine. Dynamically increasing the amount of fire retardant released can achieve the desired coverage level of 6 in the ravine bottom. As the ravine becomes shallower, the higher drop rate of the fire retardant can be decreased gradually to a level of 6 over flat terrain. This change in drop rate for the fire retardant as the elevation of the terrain changes can achieve a uniform coverage level of fire retardant throughout the ravine.

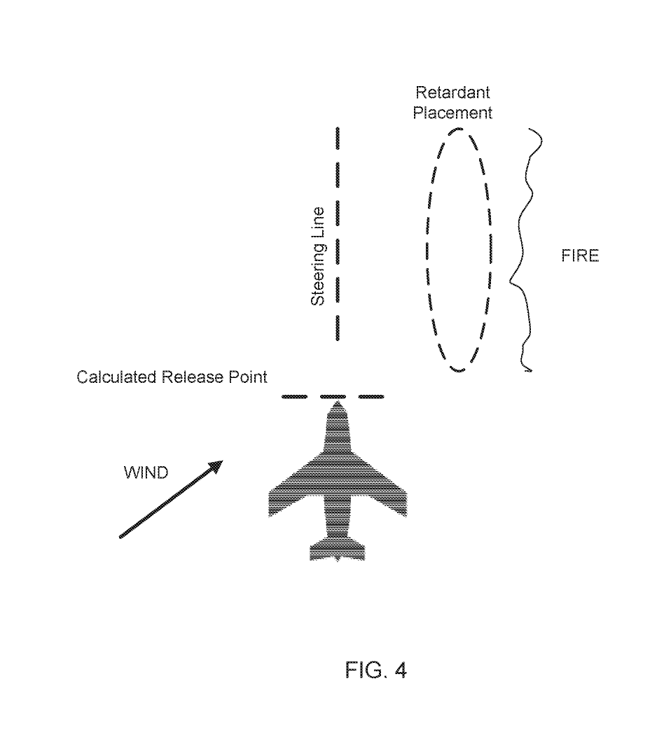

FIG. 4 illustrates an example of fire retardant being placed by an airborne vehicle in the presence of wind and other air conditions. The air conditions data can include such variables as the airspeed and direction of the airborne vehicle, the velocity of the wind, the altitude of the airborne vehicle, and the dive of the airborne vehicle. These variables can affect the ballistics of the fire retardant in relation to a desired placement on the ground, and can be referred to collectively as air conditions data.

In this example, from the air conditions data, a steering line for the airborne vehicle can be provided. The airborne vehicle can follow the wind-corrected steering line all the way to the calculated release point to provide the placement of fire retardant at the computed area on the ground. As shown, once released the fire retardant will be affected by the left quartering tailwind and through calculations will precisely drift to the fire's edge in a way that avoids wastage of fire retardant.

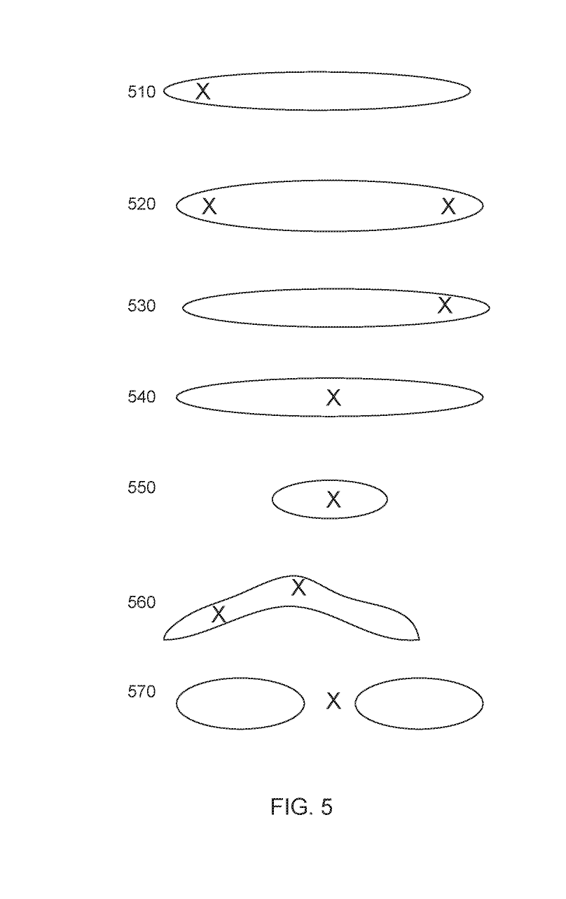

FIG. 5 illustrates an example of the different modes which define drop point types, styles or patterns that can be selected for dropping fire retardant in a desired area. In mode 510, identified as start point full load, the fire retardant can be precisely placed at the start point coordinates indicated by the “x” and continued until the full load is dispensed. In mode 520, identified as start-stop, the fire retardant release or placement can be initiated at the “x” and continued until the calculations determine the retardant will reach the other “x.” and then the door can be closed. In mode 530, identified as roll-up to stop, the computer calculates the start of the release such that the end of the full load will roll-up to the “x.” In mode 540, identified as center-the-load, the fire retardant can be released to ensure half the load is placed before the “x” and the other half after the “x”. In mode 550, identified as salvo, the fire retardant can be placed in the center of a desired area with the doors set to full open to achieve maximum possible coverage level over minimal area. In mode 560, identified as turning drop, the fire retardant can be released at the “x” and the airborne vehicle can commence an arcing flight path using the subsequent “x” and continue releasing from there. In mode 570, identified as create a gap, the fire retardant can be released in two rounds equally spaced on either side of an “x” to avoid polluting streams, rivers, major roads, etc. These different modes can be input into a computer, along with other factors such as fluid dynamics, air conditions data, a location, a ballistic model, a digital terrain elevation database (DTED), and/or a global positioning system (GPS) with wide area augmentation system (WAAS), to produce various outputs including a steering cue, a release cue, a clearance plane, and a tank control.

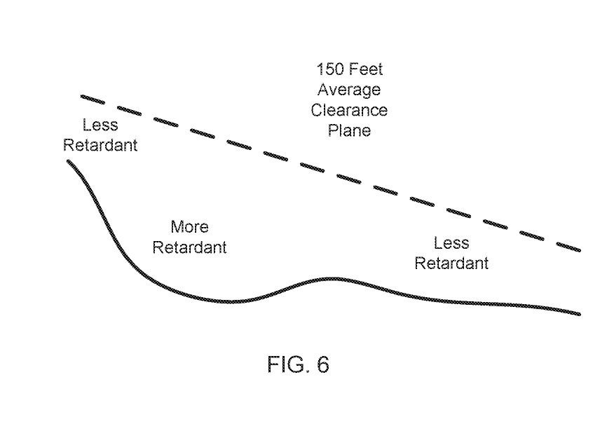

FIG. 6 illustrates an example of the clearance plane of an airborne vehicle over a hill. In this example, the average clearance plane is 150 feet over the hill; however, the distance between the airborne vehicle and the ground varies over the hill. Initially, less retardant can be dropped because the distance between the airborne vehicle is less than the average clearance plane. As the airborne vehicle travels across the clearance plane, more retardant can be dropped to compensate for the amplified dispersal effects due to increased fall distance between the airborne vehicle and the ground. As the airborne vehicle travels farther, the distance between the airborne vehicle and the ground once again decreases beneath the 150 feet average clearance plane. At this position, less retardant is dropped onto the ground. As was the case with the ravine, a uniform coverage level of fire retardant traversing the hill can be achieved.

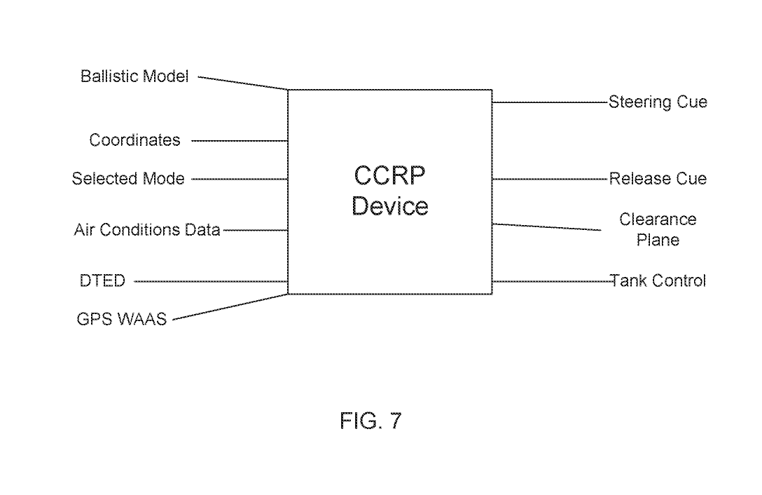

FIG. 7 illustrates an example of the inputs and outputs of the retardant delivery using a continuously-computed release point (CCRP) device. The six inputs can include (but are not limited to): a ballistic model of the fire retardant or fire suppressant (water, gel, foam); coordinates of the airborne vehicle; target coordinates, a selected mode for the released fire retardant; air conditions data, including the air speed and direction of the airborne vehicle, the velocity of the wind, the altitude of the airborne vehicle, and the dive of the airbome vehicle; a digital terrain elevation database (DTED), and/or global positioning system (GPS) with wide area augmentation system (WAAS). The four outputs can include (but are not limited to): a steering cue for the airborne vehicle; a release cue for the fire retardant; a clearance plane for the airborne vehicle; and a tank control of the fire retardant. Using fluid dynamics calculations, a ballistic model can be used to determine the ballistic flight of the fire retardant or fire suppressant from the airborne vehicle to the ground.

Target coordinate generation can be important and can be achieved by existing methods such as overfly, a laser designator, a georeferenced map, or a handheld GPS. Overfly can generate coordinates in a simple way by flying over the target. In one example, a lead plane can perform a low pass over the target location and determine an electronic ‘mark’ point and track bearing. In another example, a person on the ground near the target location can determine an electronic ‘mark’ point. In both examples, the electronic ‘mark’ point can be transmitted by wireless datalink to the airborne vehicle (e.g., plane or helicopter). A laser designator, which is a laser light source used to designate a target, can also be used to generate coordinates. The laser designator can be used from a spotter plane and the generated coordinates can be transmitted by wireless datalink to the airborne vehicle. In another example, an electro-optical infrared (EO/IR) sensor (e.g., a forward-looking infrared (FLIR) ball) can be used to determine the coordinates and bearing lines. A georeferenced map, in which the internal coordinate system of a map or aerial photo image can be related to a ground system of geographical coordinates, can be used to generate coordinates. A handheld global positioning system (GPS) device can also be used to generate coordinates. Once accurate target coordinates are generated they can be input into the retardant delivery system computer by manually typing or automatically by wireless datalink.

Another aspect that can be included in a fire retardant delivery system is wind correction calculations. The amount of wind in the atmosphere can affect the movement (or drift) of the fire retardant after the fire retardant has been released from the airborne vehicle. Modern aircraft avionics continually sense, calculate, and report the wind effects on the air vehicle. This data can be used in the ballistic calculations of a fire retardant delivery system.

A DTED can be used in a precision fire retardant delivery system to map the underlying terrain. The distance between the airborne vehicle and the ground continuously changes based on the underlying topography. For example, if an airborne vehicle is traveling over a ravine or a hill, then the distance between the airborne vehicle and terrain can change. The drift and dispersal of the retardant will vary based on different relative airtimes thereby affecting ground coverage level consistency of fire retardant as the underlying terrain changes. This change in coverage level consistency can affect the ability of the fire retardant to prevent the spread of the fire by allowing burn through in areas where the coverage level is low or weak.

A GPS WAAS interface can be used to determine the location of the airborne vehicle in relation to the targeted areas. The WAAS can improve the accuracy and integrity of GPS, and can be further enhanced by a local area augmentation system (LAAS) in some areas. GPS WAAS can provide accuracy that approaches 1 m laterally and 1.5 meters vertically throughout the contiguous United States.

In another example of precision retardant delivery system utility, firefighters and other people in or around the location of a fire can have a personal locator. A personal locator can transmit a location of a person to a fire-retardant delivery system. Based on the location of the person, the fire-retardant delivery system can modify or terminate delivery in order to prevent the release of retardant on the person on the ground. In one example, the locations of people on the ground can be received by the fire-retardant delivery system and used as another input to the fire-retardant delivery system to affect the resulting outputs such as a steering cue for the airborne vehicle; a release cue for the fire retardant, a clearance plane for the airborne vehicle; and a tank control of the fire retardant. In another example, when fire-retardant delivery cannot be effectuated without injury to people on the ground, the fire-retardant system can terminate delivery of the fire-retardant. As a last resort life saving measure, the precision retardant delivery system can be utilized in an emergency mode to drop on fire fighters who are at imminent threat of a burn over (FIG. 5. 550).

Current fire retardant delivery systems employ a mechanical button that is electrically wired to command drop doors to open at preset rates. A fire retardant delivery system with improved precision delivery can also interface with these existing retardant delivery systems by inserting a retardant delivery computing device in the loop between the existing button and the doors. In addition, a precision fire retardant delivery system can include an emergency fail-safe option, in which the fire retardant can be released manually if needed.

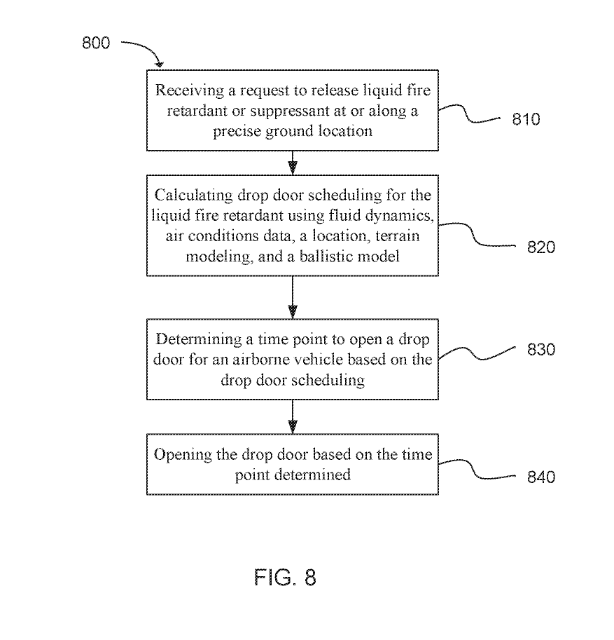

FIG. 8 shows another example of a computing method to perform precision retardant delivery. The method can comprise receiving a request to release liquid fire retardant or fire suppressant at or along a precise ground location, as in block 810. The method can further comprise calculating drop door scheduling for the liquid fire retardant using fluid dynamics, air conditions data, a location, terrain modeling, and a ballistic model, as in block 820. The method can further comprise determining a time point to open a drop door for an airborne vehicle based on the drop door scheduling, as in block 830. The method can further comprise opening the drop door based on the time point determined, as in block 840.

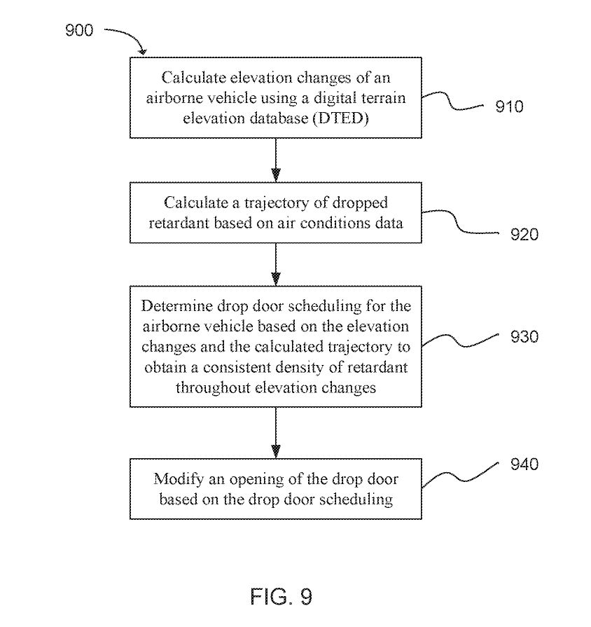

Another example provides functionality 900 of an apparatus for performing precision fire retardant delivery, the apparatus comprising one or more processors and memory, as shown in FIG. 9. The one or more processors and memory can be configured to calculate elevation changes of an airborne vehicle using a digital terrain elevation database (DTED), as in block 910. The one or more processors and memory can be configured to calculate a trajectory of dropped retardant based on air conditions data, as in block 920. The one or more processors and memory can be configured to determine drop door scheduling for the airborne vehicle based on the elevation changes and the calculated trajectory to obtain a consistent density of retardant throughout elevation changes, as in block 930. The one or more processors and memory can be configured to modify an opening of the drop door based on the drop door scheduling, as in block 940.

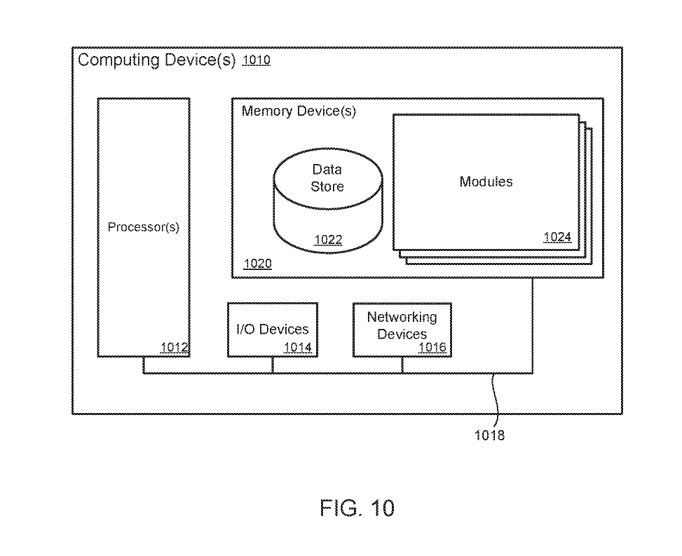

FIG. 10 illustrates a computing device 1010 on which modules of this technology may execute. A computing device 1010 is illustrated on which a high level example of the technology may be executed. The computing device 1010 may include one or more processors 1012 that are in communication with memory devices 1020. The computing device 1010 may include a local communication interface 1018 for the components in the computing device. For example, the local communication interface 1018 may be a local data bus and/or any related address or control busses as may be desired.

The memory device 1020 may contain modules 1024 that are executable by the processor(s) 1012 and data for the modules 1024. The modules 1024 may execute the functions described earlier. A data store 1022 may also be located in the memory device 1020 for storing data related to the modules 1024 and other applications along with an operating system that is executable by the processor(s) 1012.

Other applications may also be stored in the memory device 1020 and may be executable by the processor(s) 1012. Components or modules discussed in this description that may be implemented in the form of software using high-level programming languages that are compiled, interpreted or executed using a hybrid of the methods.

The computing device may also have access to I/O (input/output) devices 1014 that are usable by the computing devices. Networking devices 1016 and similar communication devices may be included in the computing device. The networking devices 1016 may be wired or wireless networking devices that connect to the internet, a LAN, WAN, a datalink, or other computing network.

The components or modules that are shown as being stored in the memory device 1020 may be executed by the processor(s) 1012. The term “executable” may mean a program file that is in a form that may be executed by a processor 1012. For example, a program in a higher level language may be compiled into machine code in a format that may be loaded into a random access portion of the memory device 1020 and executed by the processor 1012, or source code may be loaded by another executable program and interpreted to generate instructions in a random access portion of the memory to be executed by a processor. The executable program may be stored in any portion or component of the memory device 1020. For example, the memory device 1020 may be random access memory (RAM), read only memory (ROM), flash memory, a solid state drive, memory card, a hard drive, optical disk, floppy disk, magnetic tape, or any other memory components.

The processor 1012 may represent multiple processors and the memory device 1020 may represent multiple memory units that operate in parallel to the processing circuits. This may provide parallel processing channels for the processes and data in the system. The local interface 1018 may be used as a network to facilitate communication between any of the multiple processors and multiple memories. The local interface 1018 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices such as radios or datalinks. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method for performing fire suppressant delivery from an airborne vehicle, comprising:
receiving a request to release fire suppressant at or along a ground location;
calculating drop door scheduling for the fire suppressant using fluid dynamics, air conditions data, a location, terrain modeling, and a ballistic model;
providing electronic pilot cueing to guide a pilot to a location for fire suppressant placement;
determining a time point to open a drop door for an airborne vehicle based on the drop door scheduling; and
opening the drop door based on the time point determined to release the fire suppressant.

2. The method of claim 1, further comprising:
using digital terrain data to compute the drop door scheduling.

3. The method of claim 1, further comprising:
determining a time point to close the drop door for the airborne vehicle based on the drop door scheduling; and
closing the drop door based on the drop door scheduling.

4. The method of claim 1, further comprising:
determining the drop door scheduling based on a coverage level for the fire suppressant, wherein the coverage level determines an amount of retardant for a level square area.

5. The method of claim 1, further comprising:
increasing an opening width for the drop door as a height of the airborne vehicle increases.

6. The method of claim 1, further comprising:
decreasing an opening width for the drop door as a height of the airborne vehicle decreases.

7. An apparatus for performing fire retardant delivery, the apparatus comprising one or more processors and memory configured to:
calculate elevation changes of an airborne vehicle using a digital terrain elevation database (DTED);
calculate a trajectory of dropped retardant based on air conditions data;
determine drop door scheduling for the airborne vehicle based on the elevation changes and the calculated trajectory to obtain a consistent density of retardant throughout elevation changes; and
modify an opening of the drop door based on the drop door scheduling.

8. The apparatus of claim 7, wherein the one or more processors and memory are further configured to:
open the drop door based on the drop door scheduling; or
close the drop door based on the drop door scheduling.

9. The apparatus of claim 7, wherein the drop door scheduling is further determined based on at least one of: a ballistic model; geographical coordinates; or a selected mode defining a drop point type.

10. The apparatus of claim 7, wherein the drop door scheduling is determined based on a coverage level for the fire retardant, wherein the coverage level determines an amount of retardant for a level square area.

11. The apparatus of claim 7, wherein the one or more processors and memory are further configured to:
determine a flight path using a pre-defined retardant placement, wherein the pre-defined retardant placement is based on at least one of: starting coordinates; a line of bearing at starting coordinates; stopping coordinates; or a line of bearing at stopping coordinates.

12. The apparatus of claim 7, wherein the one or more processors and memory are further configured to increase an opening width for the drop door as a height of the airborne vehicle increases.

13. The apparatus of claim 7, wherein the one or more processors and memory are further configured to decrease an opening width for the drop door as a height of the airborne vehicle decreases.

14. The apparatus of claim 7, wherein the one or more processors are further configured to determine drop door scheduling using geographical coordinates received via a pilot visual cueing device.

15. The apparatus of claim 14, wherein the pilot visual cueing device includes at least one of a heads-up display (HUD), a helmet-mounted cueing (HMC) device, or augmented-reality glasses.

16. The apparatus of claim 7, wherein the one or more processors and memory are further configured to determine drop door scheduling based on one or more of fluid dynamics, a location, a global positioning system (GPS) with wide area augmentation system (WAAS), or a location from a personal locator.

17. At least one non-transitory machine readable storage medium having instructions embodied thereon, the instructions when executed by one or more processors at a fire-retardant delivery system perform the following:
calculating elevation changes of an airborne vehicle using a digital terrain elevation database (DTED);
calculating a trajectory of dropped retardant based on air conditions data;
determining drop door scheduling for the airborne vehicle based on the elevation changes and the calculated trajectory to obtain a consistent density of retardant throughout elevation changes; and
modifying an opening or closing rate of the drop door based on the drop door scheduling.

18. The at least one non-transitory machine readable storage medium of claim 17, further comprising instructions that when executed perform the following:
determining the drop door scheduling based on at least one of: a ballistic model; geographical coordinates; a selected mode; fluid dynamics; a location; a global positioning system (GPS) with wide area augmentation system (WAAS); or a location from a personal locator.

19. The at least one non-transitory machine readable storage medium of claim 17, further comprising instructions that when executed perform the following:
determining drop door scheduling based on a pilot visual cueing device.

20. The at least one non-transitory machine readable storage medium of claim 19, wherein the pilot visual cueing device includes one or more of a heads-up display (HUD), a helmet-mounted cueing (HMC) device, or augmented-reality glasses.
